(19) United States
(12) Patent Application Publication
(10) Pub. No.: US 2018/0004423 A1
(43) Pub. Date: Jan. 4, 2018

(54) ELECTRONIC DEVICE AND REMOTE CONTROL SYSTEM

(71) Applicant: Panasonic Intellectual Property Management Co., Ltd., Osaka (JP)

(72) Inventor: Shunsuke SAITO, Osaka (JP)

(21) Appl. No.: 15/707,032

(22) Filed: Sep. 18, 2017

Related U.S. Application Data
(63) Continuation of application No. PCT/JP2016/000971, filed on Feb. 24, 2016.

(30) Foreign Application Priority Data
Mar. 27, 2015 (JP) 2015-067425

(51) Int. Cl. G06F 3/06; G06F 11/07; H04W 4/14

(52) U.S. Cl. CPC G06F 3/0605; H04W 4/14; G06F 3/0652; G06F 3/0653; G06F 11/0709

(57) ABSTRACT

A computer includes an SMS module that communicates with a management server apparatus via a network, a display that displays predetermined information, and a CPU that controls an operation of the display. When the SMS module receives a control command from the management server apparatus via the network, the CPU executes processing corresponding to the control command. Furthermore, the CPU transmits a notification signal including information, which indicates a state of execution of the control program, to the management server apparatus via the network.

Furthermore, the CPU displays, on the display, a state indicator including information which indicates a state of execution of the control program when the notification signal cannot be transmitted to the management server apparatus via the network.

### BACKGROUND

### 1. Technical Field

The present disclosure relates to an electronic device that is remotely controlled by a management server apparatus via a network. The present disclosure also relates to a remote control system including such an electronic device and a management server apparatus.

### 2. Description of the Related Art

An administrator or a user is sometimes required to remotely control an electronic device in order to manage a plurality of electronic devices such as computers (see, for example, Unexamined Japanese Patent Publication Nos. 2002-051377 and 2008-090469).

### SUMMARY

The present disclosure provides an electronic device that is remotely controlled by a management server apparatus via a network and that can transmit progress and a result of execution of a control command to an administrator or a user even if network connection of the electronic device is lost. The present disclosure also provides a remote control system including such an electronic device and a management server apparatus.

An electronic device according to an aspect of the present disclosure includes a communication unit that communicates with a management server apparatus via a network, a display that displays predetermined information, and a controller that controls an operation of the display. When the communication unit receives a control command from the management server apparatus via the network, the controller executes processing corresponding to the control command. Furthermore, the controller transmits a notification signal including information, which indicates a state of execution of the processing, to the management server apparatus via the network. When the controller fails to transmit the notification signal to the management server apparatus via the network, the controller causes a state indicator including the information which indicates the state of execution of the processing to be displayed on the display.

### BRIEF DESCRIPTION OF THE DRAWINGS

FIG. 1 is a block diagram illustrating a configuration of a remote control system according to a first exemplary embodiment;

FIG. 2 is a sequence diagram illustrating a first example of an operation of the remote control system in FIG. 1;

FIG. 3 is a view illustrating a format of a short message including a deletion command of FIG. 2;

FIG. 4 is a sequence diagram illustrating a second example of an operation of the remote control system in FIG. 1;

FIG. 5 is a view illustrating an example of a state indicator displayed on a display of a computer of FIG. 1;

FIG. 6 is a block diagram illustrating a configuration of a remote control system according to a second exemplary embodiment; and

FIG. 7 is a sequence diagram illustrating an example of an operation of the remote control system in FIG. 6.

### DETAILED DESCRIPTION

Exemplary embodiments will be described herein in detail with reference to the drawings appropriately. However, detailed descriptions more than necessary might be sometimes omitted. For example, in some cases, detailed description of already well-known items and repeated description of substantially the same configuration will be omitted. These omissions are made to avoid unnecessary redundancy of the following description, and to facilitate the understanding of those skilled in the art.

Note that the inventor of the present disclosure provides the accompanying drawings and the following description in order to allow those skilled in the art to fully understand the present disclosure, and does not intend to limit the subject matter as described in the appended claims

### First Exemplary Embodiment

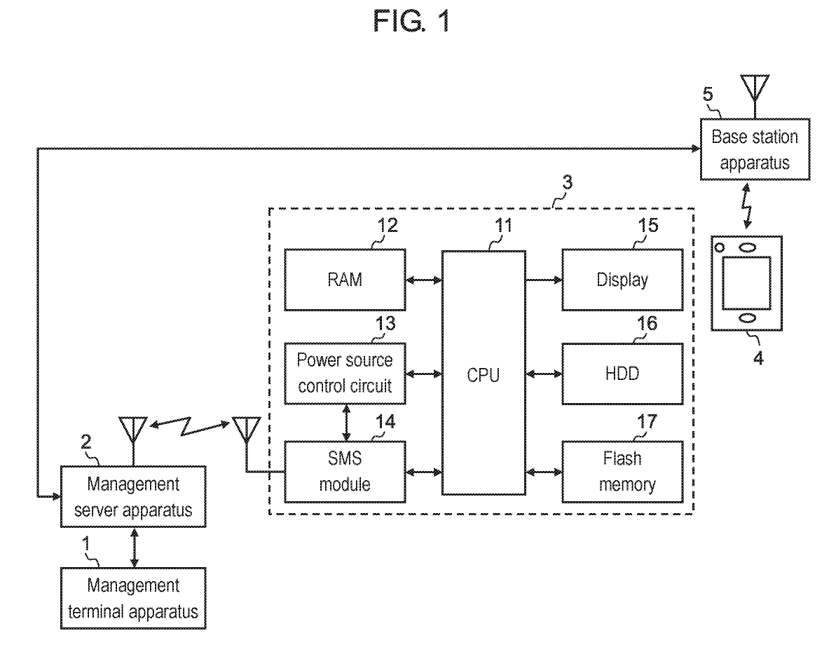

A remote control system according to a first exemplary embodiment is described below with reference to FIGS. 1 to 5.

### 1-1. Configuration

FIG. 1 is a block diagram illustrating a configuration of a remote control system according to the first exemplary embodiment. The remote control system of FIG. 1 includes management terminal apparatus 1, management server apparatus 2, computer 3, mobile terminal apparatus 4, and base station apparatus 5.

Management terminal apparatus 1 and management server apparatus 2 are connected to each other, for example, via the Internet. Management server apparatus 2 includes a gateway between the Internet and a short message service (SMS) network such as 3G or long term evolution (LTE). Management server apparatus 2 and computer 3 are connected to each other via the SMS network and transmit and receive a short message to and from each other. The remote control system of FIG. 1 includes at least one computer (electronic device) 3, and a state of each computer 3 is managed by management server apparatus 2. In this case, an administrator manages each computer 3 by accessing management server apparatus 2 from management terminal apparatus 1. Management of each computer 3 includes, for example, issuance of a control command to each computer 3 and checking of a state of each computer 3 upon receipt of a result of execution of the control command from each computer 3. Management terminal apparatus 1 includes an input/output device such as a keyboard or a display used by the administrator.

Computer 3 includes central processing unit (CPU) 11, random access memory (RAM) 12, power source control circuit 13, SMS module 14, display 15, hard disk drive (HDD) 16, and flash memory 17.

CPU 11, RAM 12, power source control circuit 13, SMS module 14, display 15, HDD 16, and flash memory 17 function as controllers that control an operation of whole computer 3.

Display 15 is a display that displays predetermined information.

HDD 16 is a storage in which an operating system (OS), an application program, and user data are stored. Flash memory 17 stores a basic input/output system (BIOS) code. CPU 11 reads the BIOS code in flash memory 17 and the OS in HDD 16 onto RAM 12 and executes the BIOS code and the OS.

SMS module 14 is a wide-area wireless module that can transmit and receive SMS and is a communication unit that communicates with management server apparatus 2 via the SMS network.

Power source control circuit 13 controls supply of electric power to the constituent elements provided in computer 3. In particular, power source control circuit 13 supplies electric power to SMS module 14 during an operating state and a non-operating state of the BIOS and the OS so that SMS module 14 can communicate with management server apparatus 2 even during the non-operating (off) state of the BIOS and the OS.

Mobile terminal apparatus 4 includes a camera that is capable of taking an image, especially display contents on display 15 and a communication unit that is capable of communicating with management server apparatus 2. Mobile terminal apparatus 4 may be, for example, a general-purpose mobile phone or smartphone or may be a dedicated-purpose terminal apparatus for the remote control system. Mobile terminal apparatus 4 communicates with base station apparatus 5 by using the communication unit. Base station apparatus 5 is, for example, a base station apparatus of a mobile phone or an access point of a wireless local area network (LAN) and is connected to management server apparatus 2, for example, via the Internet. Accordingly, mobile terminal apparatus 4 communicates with management server apparatus 2 via base station apparatus 5.

### 1-2. Operation

An operation of the remote control system of FIG. 1 is described below.

In the first exemplary embodiment, a case where computer 3 is configured to be capable of communicating with management server apparatus 2 even in a non-operating state of the BIOS and the OS is described.

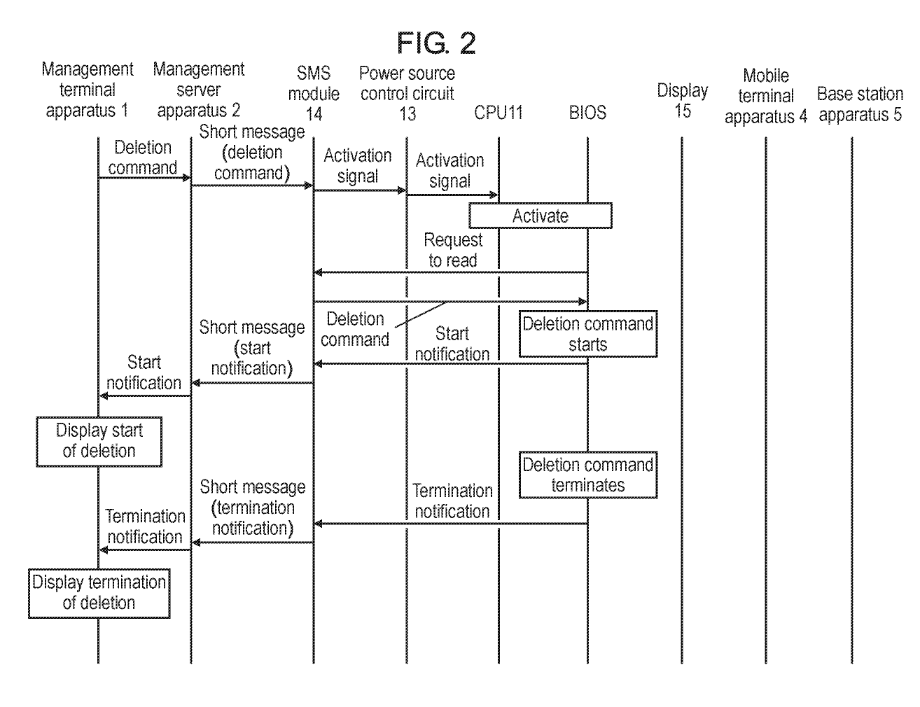

FIG. 2 is a sequence diagram illustrating a first example of an operation of the remote control system in FIG. 1.

In an initial state, the BIOS and the OS of computer 3 has not been activated, but SMS module 14 is communicating with management server apparatus 2. An administrator who tries to remotely control computer 3 issues a control command by accessing management server apparatus 2 from management terminal apparatus 1. The following describes a case where a deletion command to delete data in HDD 16 is issued as the control command. Management server apparatus 2 generates a short message including the deletion command and then transmits the short message to computer 3.

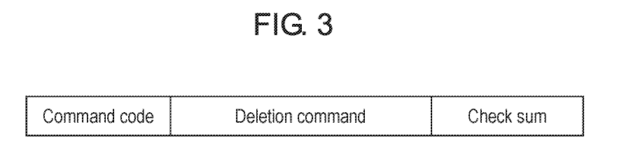

FIG. 3 is a view illustrating a format of the short message including the deletion command of FIG. 2. The command code is an operation code of SMS. A deletion command field of FIG. 3 indicates contents of processing which the administrator tries to cause computer 3 to execute.

With reference to FIG. 2 again, upon receipt of the short message including the deletion command from management server apparatus 2, SMS module 14 stores the deletion command and sends an activation signal to power source control circuit 13. Upon receipt of the activation signal from SMS module 14, power source control circuit 13 sends the activation signal to CPU 11 in order to activate the BIOS of computer 3. Furthermore, power source control circuit 13 records, in a register of power source control circuit 13 (or a register of CPU 11), information indicating that trigger of activation of computer 3 is receipt of the short message. Power source control circuit 13 can determine, as hardware for example, that the trigger of activation of computer 3 is not ON of a power source switch, but receipt of the short message. Upon receipt of the activation signal from power source control circuit 13, CPU 11 activates the BIOS by reading the BIOS code from flash memory 17.

CPU 11 continues to execute the BIOS code without activating the OS in a case where CPU 11 determines that the trigger of activation of computer 3 is receipt of the short message by referring to the register of power source control circuit 13 (or the register of CPU 11). CPU 11 sends, to SMS module 14, a request signal requesting reading of the deletion command. In response to this, SMS module 14 sends the deletion command stored in SMS module 14 to the BIOS.

CPU 11 interprets the deletion command obtained from SMS module 14 and executes a control program corresponding to the deletion command. The control program is, for example, part of the BIOS such as a program incorporated in advance as part of the BIOS code. CPU 11 instructs HDD 16 to delete, for example, all data in HDD 16 including the OS and user data (including cache of the OS, user's ID and password, and the like). The deletion command may be a deletion command determined in advance by a manufacturer of HDD 16, such as a command to delete data from a head sector of HDD 16 or a command to delete data for the purpose of obfuscation.

CPU 11 executes a BIOS code for causing SMS module 14 to send, to management server apparatus 2, a notification signal including information indicative of a state of execution of the control program (e.g., a result of processing in at least one step that is being executed by the control program). For example, CPU 11 may transmit a start notification signal indicating that the control program has started at the start of the control program, may transmit a termination notification signal indicating that the control program has terminated at the termination of the control program, or may transmit a notification signal indicating a progress in another step of the control program.

When the start notification signal is transmitted, CPU 11 executes a BIOS code for sending a request signal requesting transmission of the start notification signal to SMS module 14. SMS module 14 generates a short message including the start notification signal and then transmits the short message to management server apparatus 2. Upon receipt of the short message including the start notification signal from computer 3, management server apparatus 2 sends the start notification signal to management terminal apparatus 1. Upon receipt of the start notification signal from management server apparatus 2, management terminal apparatus 1 displays information indicating that the control program has started (e.g., start of deletion) on a display of management terminal apparatus 1.

The same applies to a case where the termination notification signal is transmitted.

The notification signal (e.g., the start notification signal and the termination notification signal) transmitted from computer 3 to management server apparatus 2 includes, for example the following items:

a model number of computer 3;

a production number of computer 3;

an activation condition of the deletion command;

a status of the deletion command (not issued, being issued, being executed, completed);

time and date of issuance of the deletion command;

time and date of completion of the deletion command;

a state of a power source (operating/sleeping/halting/AC operation/battery operation, charging rate of battery) at time of execution of the deletion command;

time and date of last time when the power source was turned on;

time and date of last activation of the OS;

a serial number of HDD;

a number of times of unauthorized activation; and

positional information of computer 3 (latitude and longitude, accuracy, time and date of measurement, link to a map).

The start notification signal includes time and date of issuance of the deletion command and does not have to include time and date of completion of the deletion command. The termination notification signal includes time and date of completion of the deletion command and does not have to include time and date of issuance of the deletion command. Alternatively, the termination notification signal may include both time and date of issuance of the deletion command and time and date of completion of the deletion command.

CPU 11 may execute the BIOS code for turning off the power source of computer 3 when the control program terminates.

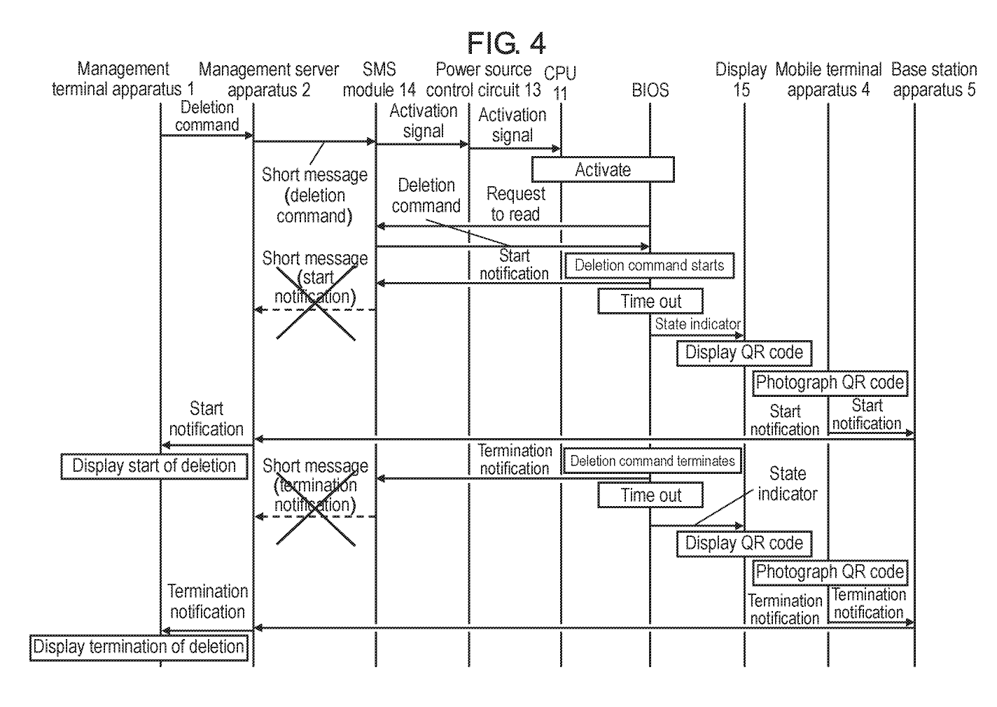

As described above, when the remote control system of FIG. 1 operates in accordance with the sequence diagram of FIG. 2, the administrator can know a progress and a result of execution of the deletion command. Assume here that network connection of computer 3 is lost after the deletion command is transmitted from management server apparatus 2 to computer 3, computer 3 becomes unable to transmit information indicative of a progress and a result of execution of the deletion command to management server apparatus 2. This prevents the administrator from knowing the progress and result of execution of the deletion command. Network connection of computer 3 is sometimes lost, for example, due to deterioration of a communication environment (e.g., movement of computer 3 out of a range of the SMS network), turning off of a wireless switch of computer 3, or hardware or software failure of SMS module 14. In view of this, in such a case, the remote control system according to the present exemplary embodiment operates in accordance with the sequence diagram of FIG. 4.

FIG. 4 is a sequence diagram illustrating a second example of an operation of the remote control system in FIG. 1.

The operation in FIG. 4 is similar to the operation in the sequence diagram of FIG. 2 until the step in which CPU 11 starts the control program corresponding to the deletion command in accordance with the BIOS code. As described above with reference to FIG. 2, CPU 11 executes a BIOS code for causing SMS module 14 to transmit, to management server apparatus 2, a notification signal (e.g., the start notification signal and the termination notification signal) including information indicative of a state of execution of the control program.

When a predetermined period (a time-out period) has elapsed without completion of transmission of the start notification signal after a request signal requesting transmission of the start notification signal to SMS module 14 is transmitted in accordance with the BIOS code, CPU 11 determines that CPU 11 is incommunicable with management server apparatus 2 by using SMS module 14. In this case, the start notification signal cannot be transmitted to management server apparatus 2, and therefore CPU 11 executes a BIOS code for generating a state indicator including information indicating a state of execution of the control program (start of the control program) and then displaying this state indicator on display 15.

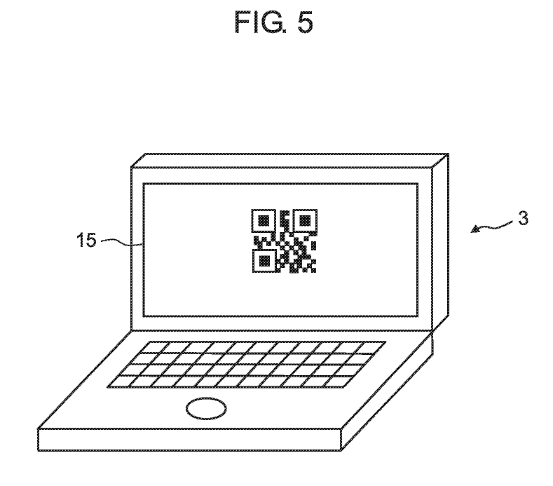

FIG. 5 is a view illustrating an example of the state indicator displayed on display 15 of computer 3 of FIG. 1. The state indicator is, for example, a quick response (QR) code (Registered Trademark, the same applies hereinafter). The state indicator includes contents similar to contents of the notification signal which CPU 11 tried to transmit by using a short message and destination information of management server apparatus 2. The destination information of management server apparatus 2 includes, for example, a uniform resource locator (URL) of management server apparatus 2 on the Internet. To the URL of management server apparatus 2, identification information unique to computer 3 may be added.

The state indicator may include a text message and/or an error code in addition to the QR code or instead of the QR code.

With reference to FIG. 4 again, when the state indicator (QR code) indicative of the state of the control program is displayed on display 15, a user or an administrator of computer 3 or a third party photographs the state indicator displayed on display 15 of computer 3 by using the camera of mobile terminal apparatus 4. Mobile terminal apparatus 4 interprets the photographed state indicator and transmits a start notification signal indicating that the control program has started to management server apparatus 2 specified by the destination information included in the state indicator. For this purpose, mobile terminal apparatus 4 transmits the start notification signal to base station apparatus 5. Upon receipt of the start notification signal from mobile terminal apparatus 4, base station apparatus 5 sends the start notification signal to management server apparatus 2. Upon receipt of the start notification signal from base station apparatus 5, management server apparatus 2 sends the start notification signal to management terminal apparatus 1. Upon receipt of the start notification signal from management server apparatus 2, management terminal apparatus 1 displays information indicating that the control program has started (e.g., start of deletion) on the display of management terminal apparatus 1.

Also when the terminal notification signal cannot be transmitted to management server apparatus 2 due to failure to communication with management server apparatus 2 by using SMS module 14, CPU 11 executes a BIOS code for generating a state indicator including information indicating that the control program has terminated and then displaying this state indicator on display 15. A user or an administrator of computer 3 photographs the state indicator displayed on display 15 of computer 3 by using the camera of mobile terminal apparatus 4. Communication between mobile terminal apparatus 4 and management server apparatus 2 is similar to that in the case of the state indicator (the QR code) including the start notification signal. When a notification signal (not limited to the start notification signal and the termination notification signal) including information indicating the state of execution of the control program cannot be transmitted to management server apparatus 2, CPU 11 may execute a BIOS code for generating a state indicator including information indicative of a state of execution of the control program and then displaying this state indicator on display 15. Also in this case, the user or the administrator of computer 3 may photograph the state indicator displayed on display 15 of computer 3 by using the camera of mobile terminal apparatus 4.

Once time-out occurs without completion of transmission of the notification signal, CPU 11 may determine that network connection has been lost and thereafter always execute a BIOS code for displaying a state indicator including information indicative of a state of execution of the control program on display 15 without transmitting the notification signal to management server apparatus 2 by using SMS module 14.

CPU 11 may turn off the power source of computer 3 once after the control program terminates and the state indicator including information indicating that the control program has terminated is displayed on display 15. In this case, CPU 11 records, in the register (e.g., a storage region in the BIOS) provided in CPU 11, information indicating the state of execution of the control program. After the power source of computer 3 is turned on and the BIOS is activated, CPU 11 executes a BIOS code for checking this register and displaying the state indicator including the information indicating the state of execution of the control program on display 15 again.

A progress and a result of execution of a control command can be transmitted to management server apparatus 2 by the operation of the remote control system of FIG. 1 in accordance with the sequence diagram of FIG. 4. Accordingly, even if network connection of computer 3 is lost, an administrator or a user can know the progress and the result of execution of the control command.

### 1-3. Effects and Other Benefits

According to the remote control system of FIG. 1, when computer 3 is configured to be capable of communicating with management server apparatus 2 even during a non-operating state of the BIOS and the OS, an administrator or a user can be notified of a progress and a result of execution of a control command even if network connection of computer 3 is lost.

The remote control system of FIG. 1 is applicable, for example, to a case where data stored in a storage of a computer to be discarded is remotely deleted. Conventionally, when a lease of a computer (personal computer) used in a company or the like expires or the computer is discarded, the computer is sent from an end user at a branch office to an administrator at a head office by using security protection delivery service and then data in a storage is deleted. This requires a high transportation cost. Even though the end user is requested to delete the data in the storage, the end user sometimes send the computer without deleting the data or does not use a designated deletion program. Therefore, use of a security protection delivery service is conventionally essential. Meanwhile, the remote control system of FIG. 1 makes it possible to remotely delete data and automatically notify an administrator of a result of the deletion. In the case of a general computer, when data in a storage is deleted, an OS is also deleted. It is therefore impossible to confirm on-line that the data in the storage has been completely deleted. Meanwhile, according to the remote control system of FIG. 1, completion of deletion of data in a storage can be detected by a BIOS, and management server apparatus 2 can be notified of completion of deletion of the data via SMS module 14 or mobile terminal apparatus 4. This makes it possible to send computer 3 at low cost as a “mere box” containing no confidential information after an administrator confirms that deletion of data in a storage has been completed.

The remote control system of FIG. 1 is also applicable, for example, to a case where data stored in a storage of a stolen computer is remotely deleted. Computer 3 that has received a deletion command from management server apparatus 2 displays a QR code on display 15 together with an error code after completion of the deletion command. A third party who has acquired (stolen) computer 3 might access management server apparatus 2 by photographing the QR code in order to check error contents. In such a case where the third party accesses management server apparatus 2, management server apparatus 2 can confirm completion of deletion of data in HDD 16 of computer 3.

The control command may be a command to lock computer 3 instead of the deletion command. A message indicating how to unlock computer 3 (e.g., contact information of an administrator) may be displayed on display 15 instead of the state indicator.

The control command may be a command to perform maintenance on computer 3 instead of the deletion command. The command to perform maintenance on computer 3 includes, for example, hardware diagnosis of a CPU, a RAM, an HDD, and a network (wireless and/or wired).

According to the present exemplary embodiment, computer 3 includes SMS module 14 that communicates with management server apparatus 2 via a network, display 15 that displays predetermined information, and CPU 11 that controls an operation of display 15. When SMS module 14 receives a control command from management server apparatus 2 over the network, CPU 11 executes processing corresponding to the control command. Furthermore, CPU 11 transmits a notification signal including information, which indicates a state of execution of the processing, to management server apparatus 2 over the network. Furthermore, when the notification signal cannot be transmitted to management server apparatus 2 over the network, CPU 11 displays, on display 15, a state indicator including information which indicates a state of execution of the processing. This allows an administrator or a user to be notified of a progress and a result of execution of the control command even if network connection of computer 3 is lost.

According to the present exemplary embodiment, computer 3 is a computer that includes a BIOS and an OS. SMS module 14 communicates with management server apparatus 2 over the network even while the BIOS and the OS is in a non-operating state. When SMS module 14 receives a control command from management server apparatus 2 via the network during the non-operating state of the BIOS and the OS, CPU 11 activates the BIOS and executes processing by using the BIOS. Computer 3 can execute a control command that is not restricted by the OS. For example, when the control command is a deletion command to delete data in a storage, all of the data in the storage including the OS can be deleted.

According to the present exemplary embodiment, SMS module 14 receives a control command in the format of a short message of a short message service (SMS) from management server apparatus 2 via the network. Computer 3 can be thus easily configured to be capable of communicating with management server apparatus 2 even in a non-operating state of the BIOS and the OS.

According to the present exemplary embodiment, information indicative of a state of execution of processing includes information indicating that the processing has started and/or information indicating that the processing has terminated. This allows an administrator or a user to be notified of start and/or termination of the control command even if network connection of computer 3 is lost.

According to the present exemplary embodiment, the state indicator further includes destination information of management server apparatus 2. This allows an administrator or a user to be notified of a progress and a result of execution of the control command even if network connection of computer 3 is lost.

According to the present exemplary embodiment, the state indicator is one in a form of a QR code (Registered Trademark). This makes it possible to easily obtain a progress and a result of execution of the control command.

According to the present exemplary embodiment, computer 3 further includes a storage, and the control command instructs deletion of data in the storage. This makes it possible to easily remotely control computer 3 from management server apparatus 2 via the network.

According to the present exemplary embodiment, the remote control system includes at least one computer 3 and management server apparatus 2. Even when the remote control system includes a plurality of computers 3, an administrator can efficiently manage the plurality of computers 3.

According to the present exemplary embodiment, the remote control system further includes a camera that is capable of photographing a state indicator and a terminal device that includes a communication circuit that is capable of communicating with management server apparatus 2. This allows an administrator or a user to be notified of a progress and a result of execution of the control command even if network connection of computer 3 is lost.

### Second Exemplary Embodiment

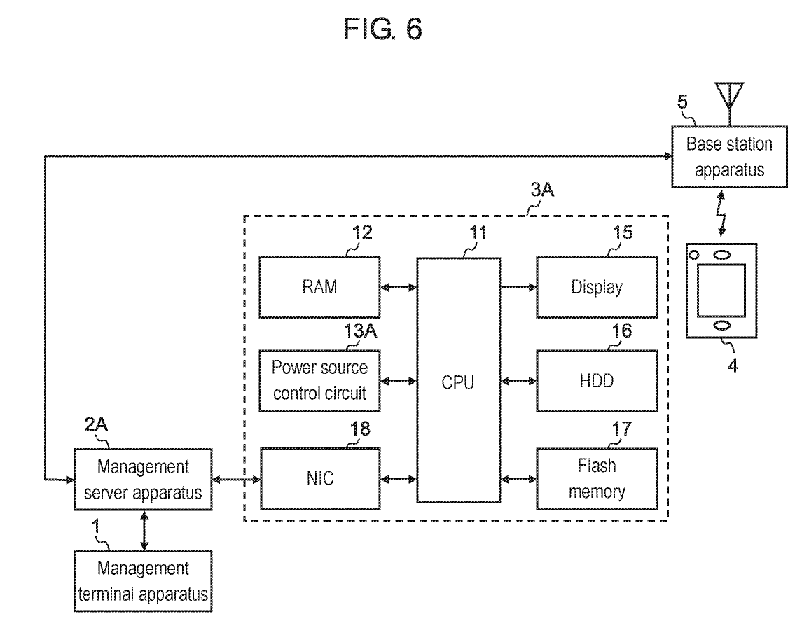

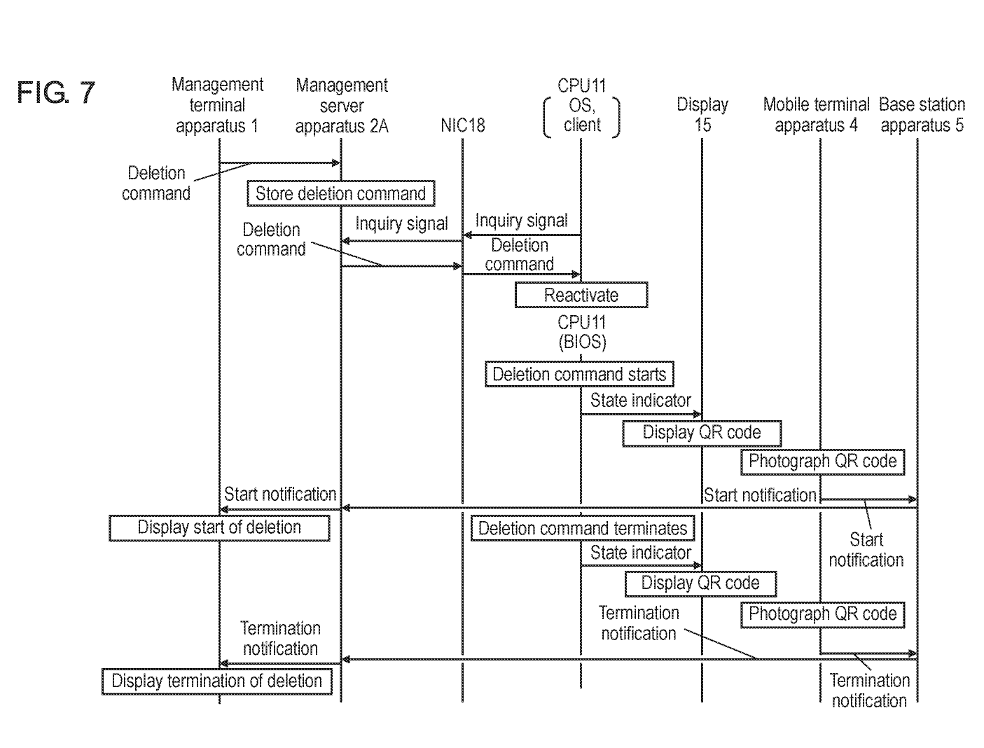

A remote control system according to a second exemplary embodiment is described below with reference to FIGS. 6 and 7.

### 2-1. Configuration

FIG. 6 is a block diagram illustrating a configuration of a remote control system according to the second exemplary embodiment. The remote control system of FIG. 6 includes management terminal apparatus 1, management server apparatus 2A, computer 3A, mobile terminal apparatus 4, and base station apparatus 5.

Management server apparatus 2A and computer 3A of FIG. 6 are connected to each other, for example, via the Internet.

Computer 3A includes CPU 11, RAM 12, power source control circuit 13A, display 15, HDD 16, flash memory 17, and network interface controller (NIC) 18. Computer 3A includes NIC 18 (a communication unit that is capable of communicating with management server apparatus 2 only during an operating state of the OS) instead of SMS module 14 of FIG. 1 (a communication unit that is capable of communicating with management server apparatus 2 even during a non-operating state of the BIOS and the OS). NIC 18 is connected to management server apparatus 2 via the Internet. Power source control circuit 13A is similar to power source control circuit 13 of FIG. 1 except for that power source control circuit 13A does not supply electric power to any of constituent elements of computer 3A during a non-operating state of the BIOS and the OS. NIC 18 may be incorporated into CPU 11.

### 2-2. Operation

An operation of the remote control system of FIG. 6 is described below. In the second exemplary embodiment, a case where computer 3A is configured to be capable of communicating with management server apparatus 2 only in an operating state of the OS is described.

FIG. 7 is a sequence diagram illustrating an example of an operation of the remote control system of FIG. 6.

An administrator accesses management server apparatus 2 from management terminal apparatus 1 in advance and stores, in management server apparatus 2, a control command for remotely controlling computer 3A. The following describes a case where a deletion command to delete data in HDD 16 is issued as the control command, as in the first exemplary embodiment.

An OS is being activated on computer 3A, and a client program of the remote control system is operating on the OS. CPU 11 executes a client program for sending an inquiry signal inquiring about the presence or absence of a deletion command to management server apparatus 2 via NIC 18. Furthermore, CPU 11 executes a client program for acquiring (downloading) the deletion command stored in management server apparatus 2.

CPU 11 executes a client program for reactivation upon receipt of the deletion command from management server apparatus 2. Before reactivation, CPU 11 executes a client program for recording, in a storage region of the BIOS, the deletion command and information indicating that trigger of reactivation of computer 3A is receipt of the deletion command from management server apparatus 2. CPU 11 activates the BIOS by reading a BIOS code from flash memory 17. When the BIOS determines that trigger of reactivation of computer 3 is receipt of the deletion command from management server apparatus 2 by referring to the storage region of the BIOS, the BIOS continues to execute the BIOS code without activating the OS. CPU 11 executes a control program corresponding to the deletion command received from management server apparatus 2.

When computer 3A is executing only the BIOS code and is not executing the OS, computer 3A cannot communicate with management server apparatus 2. Accordingly, CPU 11 displays, on display 15, a state indicator including information indicative of a state of execution of the control program. For example, CPU 11 generates a state indicator indicating that the control program has started at the time of start of the control program and generates a state indicator indicating that the control program has terminated at the time of termination of the control program.

When the state indicator (the QR code) indicating that the control program has started is displayed on display 15, a user or an administrator of computer 3A or a third party photographs the state indicator displayed on display 15 of computer 3A by using a camera of mobile terminal apparatus 4. Mobile terminal apparatus 4 interprets the photographed state indicator and transmits a start notification signal indicating that the control program has started to management server apparatus 2 specified by destination information included in the state indicator. When the state indicator (the QR code) indicating that the control program has terminated is displayed on display 15, a user or an administrator of computer 3A photographs the state indicator displayed on display 15 of computer 3A by using the camera of mobile terminal apparatus 4. Mobile terminal apparatus 4 interprets the photographed state indicator and transmits a termination notification signal indicating that the control program has terminated to management server apparatus 2 specified by destination information included in the state indicator. Communication between mobile terminal apparatus 4 and management server apparatus 2 is similar to that in the first exemplary embodiment.

CPU 11 may turn off the power source of computer 3 once when the control program terminates and after a BIOS code for displaying, on display 15, the state indicator including information indicating that the control program has terminates is executed. In this case, CPU 11 executes a BIOS code for recording, in the storage region of the BIOS, information indicative of a state of execution of the control program. After the power source of computer 3 is turned on and the BIOS is activated, CPU 11 executes a BIOS code for checking this register and displaying the state indicator including the information indicating the state of execution of the control program on display 15 again.

A progress and a result of execution of the control command can be transmitted to management server apparatus 2 by the operation of the remote control system of FIG. 6 in accordance with the sequence diagram of FIG. 7.

Accordingly, even if network connection of computer 3A is lost because of deletion of the OS by computer 3A, an administrator or a user can know the progress and the result of execution of the deletion command.

### 2-3. Effects and Other Benefits

According to the present exemplary embodiment, computer 3 is a computer that includes a BIOS and an OS. NIC 18 communicates with management server apparatus 2 via the network during an operating state of the OS. When NIC 18 receives a control command from management server apparatus 2 via the network during the operating state of the OS, CPU 11 finishes the OS and activates the BIOS and executes processing by using the BIOS. Computer 3A can thus execute a control command that is not restricted by the OS. For example, when the control command is a deletion command to delete data in a storage, all of the data in the storage including the OS can be deleted.

### Other Exemplary Embodiments

The first and second exemplary embodiments have been described above as examples of the technique disclosed herein. However, the technique of the present disclosure is not limited to the first and second exemplary embodiments, and is applicable to another exemplary embodiment in which a change, a replacement, an addition, or an omission is appropriately made. A new exemplary embodiment can also be made by a combination of the components of the first and second exemplary embodiments.

Accordingly, another exemplary embodiment will be described below.

In the first and second exemplary embodiments, computers 3 and 3A have been described as examples of the electronic device. However, the electronic device is not limited to a computer, provided that the electronic device includes a controller, a communication unit, and a display. Examples of the electronic device include a desktop personal computer, a notebook or slate personal computer, a mobile phone, and a smartphone.

In the first and second exemplary embodiments, CPU 11 has been described as an example of the controller. However, the controller is not limited to CPU 11, provided that the controller executes a control program corresponding to a control command.

In the first and second exemplary embodiments, SMS module 14 and NIC 18 have been described as examples of the communication unit. However, the communication unit is not limited to SMS module 14 and NIC 18, provided that the communication unit is connected to a management server apparatus via a network.

In the first and second exemplary embodiments, a QR code has been described as an example of the state indicator. However, the state indicator is not limited to a QR code, provided that the state indicator includes information indicative of a state of execution of a control program. The state indicator may be another kind of two-dimensional code or may be a one-dimensional code instead of a QR code.

In the first and second exemplary embodiments, a control program has been described as part of a BIOS. However, the control program is not limited to a BIOS, provided that the control program controls an operation of an electronic device. The control program may be, for example, part of a unified extensible firmware interface (UEFI) or may be part of another kind of firmware. The control program may be, for example, part of a client program that operates on an OS. In this case, during an operating state of the OS, CPU 11 may transmit a notification signal including information indicative of a state of execution of the control program to management server apparatus 2 via NIC 18 or may execute a client program for displaying, on display 15, a state indicator including information indicative of a state of execution of the control program.

In the first and second exemplary embodiments, HDD 16 has been described as an example of the storage. However, the storage is not limited to HDD 16, provided that the storage stores an OS, user data, and the like. Examples of the storage include a solid state drive (SSD) and a flash memory.

In the first and second exemplary embodiments, a deletion command has been described as an example of the control command. However, the control command is not limited to a deletion command, provided that the control command causes a managed electronic device to execute desired processing.

The state indicator may include contact information (a phone number, an e-mail address, and the like) of an administrator of computer 3 instead of destination information of management server apparatus 2.

Mobile terminal apparatus 4 may communicate with management server apparatus 2 via an SMS network instead of communicating with management server apparatus 2 via base station apparatus 5 and the Internet. In this case, destination information of management server apparatus 2 included in the state indicator may include, for example, an address on the SMS network that is capable of communicating with management server apparatus 2.

Mobile terminal apparatus 4 may be configured not to include a communication unit. In this case, a user or an administrator of computer 3 may photograph the state indicator displayed on display 15 of computer 3 by using the camera of mobile terminal apparatus 4 and transmit the photographed state indicator to management server apparatus 2 via another communication device.

The first and second exemplary embodiments may be combined. In this case, a remote control system may operate in accordance with the sequence diagram of FIG. 7 in order that an electronic device acquires a control command from a management server apparatus and may operate in accordance with the sequence diagram of FIG. 2 or 4 in order to transmit, to the management server apparatus, a notification signal including information indicative of a state of execution of a control program.

According to the present disclosure, when an electronic device is caused to execute specific processing, a QR code including a progress of the processing and a URL of the management server apparatus is displayed on a display of the electronic device as an operation in a layer lower than an OS. Even if a network adapter of the electronic device or a control program (including the OS) for the network adapter does not normally operate or is not mounted, a third party who has read the QR code can notify the management server apparatus of the progress of the processing via another network.

According to the present disclosure, a QR code including a status and a serial number of the electronic device, time and date of completion of deletion, and the like is displayed on the display after deletion of data in a storage, and the QR code is photographed by using a user's mobile terminal apparatus or the like, and thus allows a user to access the management server apparatus. Even if the electronic device itself cannot be connected to a network, the management server apparatus can be notified of completion of deletion.

According to the present disclosure,

(1) it is possible to delete data in a stolen or lost electronic device or disable functions of the electronic device,

(2) it is possible to notify a management server apparatus of start and termination of deletion of data (a progress of deletion), and

(3) it is possible to display, on a display of the electronic device, a message (the progress of deletion) and destination information (an e-mail address, a URL) of the management server apparatus, and thus allow a third party to notify the management server apparatus.

The exemplary embodiments have been described above and exemplified as the technique of the present disclosure. The accompanying drawings and detailed description have been presented for this purpose.

Accordingly, the components described in the appended drawings and the detailed description include, in order to exemplify the above described technique, not only components essential for solving the problem, but also components that are not essential. Therefore, it should not be immediately construed that these components that are not essential are essential even if the components are described in the appended drawings and the detailed description.

Since the above described exemplary embodiments are for exemplifying the technique of the present disclosure, various modifications, replacements, additions, and omissions can be made within the scope of the appended claims or of their equivalents.

According to an electronic device and a remote control system according to the present disclosure, even if network connection of the electronic device is lost, an administrator or a user can be notified of a progress and a result of execution of a control command. Accordingly, the electronic device and the remote control system according to the present disclosure are useful as a solution for management of an electronic device that cannot be connected to a network (e.g., management and maintenance of the electronic device, security protection of a storage, prevention of unauthorized use).

What is claimed is:

1. An electronic device comprising:
a communication unit that communicates with a management server apparatus via a network;
a display that displays predetermined information; and
a controller that controls an operation of the display,
wherein
when the communication unit receives a control command from the management server apparatus via the network, the controller executes processing corresponding to the control command and transmits a notification signal including information, which indicates a state of execution of the processing, to the management server apparatus via the network, and
when the controller fails to transmit the notification signal to the management server apparatus via the network, the controller causes a state indicator including the information which indicates the state of execution of the processing to be displayed on the display.

2. The electronic device according to claim 1, wherein
the electronic device is a computer that includes a basic input/output system (BIOS) and an operating system (OS);
the communication unit communicates with the management server apparatus via the network even while the BIOS and the OS is in a non-operating state; and
the controller activates the BIOS and executes the processing by using the BIOS when the communication unit receives the control command from the management server apparatus via the network while the BIOS and the OS is in the non-operating state.

3. The electronic device according to claim 1, wherein
the electronic device is a computer that includes a basic input/output system (BIOS) and an operating system (OS);
the communication unit communicates with the management server apparatus via the network while the OS is in an operating state; and
when the communication unit receives the control command from the management server apparatus via the network while the OS is in the operating state, the controller terminates the OS and activates the BIOS and executes the processing by using the BIOS.

4. The electronic device according to claim 1, wherein
the communication unit receives the control command from the management server apparatus via the network in a format of a short message of short message service (SMS).

5. The electronic device according to claim 1, wherein
the information which indicates the state of execution of the processing includes information indicating that the processing has started and/or information indicating that the processing has terminated.

6. The electronic device according to claim 1, wherein
the state indicator further includes destination information of the management server apparatus.

7. The electronic device according to claim 1, wherein the state indicator is in a form of a quick response (QR) code.

8. The electronic device according to claim 1, wherein
the electronic device further includes a storage; and
the control command is a command to delete data stored in the storage.

9. A remote control system comprising:
at least one electronic device according to claim 1; and
the management server apparatus.

10. The remote control system according to claim 9, further comprising:
a camera that is capable of capturing the state indicator; and
a terminal device including a communication unit that is capable of communicating with the management server apparatus.
